(19) United States
(12) Patent Application Publication
(10) Pub. No.: US 2019/0125125 A1
(43) Pub. Date: May 2, 2019

(54) Tortilla warmer

(71) Applicants: Ricardo Gonzalez, San Rafael, CA (US); Raul Luna, Modesto, CA (US); Kenneth A. Tarlow, San Rafael, CA (US)

(72) Inventors: Ricardo Gonzalez, San Rafael, CA (US); Raul Luna, Modesto, CA (US); Kenneth A. Tarlow, San Rafael, CA (US)

(21) Appl. No.: 15/732,350

(22) Filed: Oct. 30, 2017

(51) Int. Cl. A47J 36/32; A47J 27/00; A47J 37/08

(52) U.S. Cl. CPC A47J 36/32; A47J 37/08; A47J 27/004

(57) ABSTRACT

A portable electric tortilla warming device that allows a user to insert a stack of room temperature tortillas into the top of the device and for the device to automatically lift the tortillas, one at a time and insert them into an electric warming compartment, and once warmed, to deliver them into a receiving tray. The device is microprocessor controlled and once activated, allows the warming of multiple tortillas without human input. The tortillas are helped along by means of several motorized horizontal brushes. The tortillas are also caused to progress because the entire tortilla pathway is tilted at a forty-degree angle with respect to a table top. An exit gate prevents the tortilla from leaving the heating compartment until it is fully warmed.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable electric food warming devices and more specifically to an automatic tortilla warmer.

Tortillas are a flat round food that is well known especially in Mexico, South America and the United States. They are typically made of flower or corn and are stored in air tight containers or bags until they are to be used. Tortillas are normally heated before adding various toppings and then eaten while still warm.

Normally tortillas are heated in a pan which is placed on a gas or electric stove. The process of heating is time consuming because they can only be heated one or two at a time. The process also requires that one person be attending the heating process at all times to make sure that the tortillas are not over cooked or under cooked. This means that the designated person cannot fully participate in or enjoy the dining experience of those eating the tortillas because he or she is forced to remain at the stove to tend to the on-going output of warmed tortillas.

### BRIEF SUMMARY OF THE INVENTION

The primary object of the invention is to provide a portable tortilla warmer that can automatically warm a stack of tortillas.

Another object of the invention is to provide a tortilla warmer that can be programmed to select the number of tortillas to be warmed and the time duration of warming.

Another object of the invention is to provide a tortilla warmer that can operate independently of a person being present.

A further object of the invention is to provide a tortilla warmer that can be easily moved to any location including a kitchen counter or a dining table.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a tortilla warmer comprising: a main frame, a lift plate assembly, a first advance brush assembly, a second advance brush assembly, an electric warming assembly, an exit gate assembly, a lower tortilla receiving tray, a microprocessor, a display, an on off switch, a plurality of microprocessor selection switches, a top cover, said main frame supporting all said assemblies, said main housing being open topped and enclosing all said assemblies, said lift plate assembly capable of receiving a stack of tortillas and lifting them one at a time to be slid into said electric warming assembly, said lifted tortilla forced into said electric warming assembly with the aid of said first advance brush assembly, said lifted tortilla prevented from leaving said electric warming assembly during the warming process by said exit gate assembly, said warmed tortilla allowed to leave said electric warming assembly once fully warmed by the lowering of said exit gate assembly and to slide into said lower tortilla receiving tray with the assistance of said second advance brush assembly, said tortilla warming controlled by said microprocessor, said selection switches and said display, said upper top cover forming the top of said main housing, said on-off switch controlling the supply of AC voltage powering said tortilla warmer, so that a stack of tortillas can be inserted onto said lift plate assembly and said lift plate assembly can lift said stack of tortillas so that each tortilla exits the said stack one at time and are warmed one at a time and then allowed to proceed into said lower tortilla receiving tray, where said lower receiving tray can be removed and brought to a desired eating location.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with the lower tortilla receiving tray removed.

FIG. 3 is a partial perspective view showing the magnetic connection system for the lower tortilla tray.

FIG. 4 is an exploded view of the main frame members of the invention.

FIG. 5 is a perspective view of the main internal components of the invention.

FIG. 6 is a section view that bisects the invention.

FIG. 7 is a perspective view of the main frame of the invention.

FIG. 8 is a partial perspective view of the lift plate and drive motor.

FIG. 9 is a partial perspective view of the screw drive limit switches.

FIG. 10 is a perspective view of the inside of the invention with the top half of the heating assembly removed.

FIG. 11 is a partial perspective view showing a tortilla transitioning from the heating assembly to the lower receiving tray.

FIG. 12 is a partial perspective view showing the exit gate in the raised position.

FIG. 13 is a partial perspective view showing the exit gate in the lowered position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

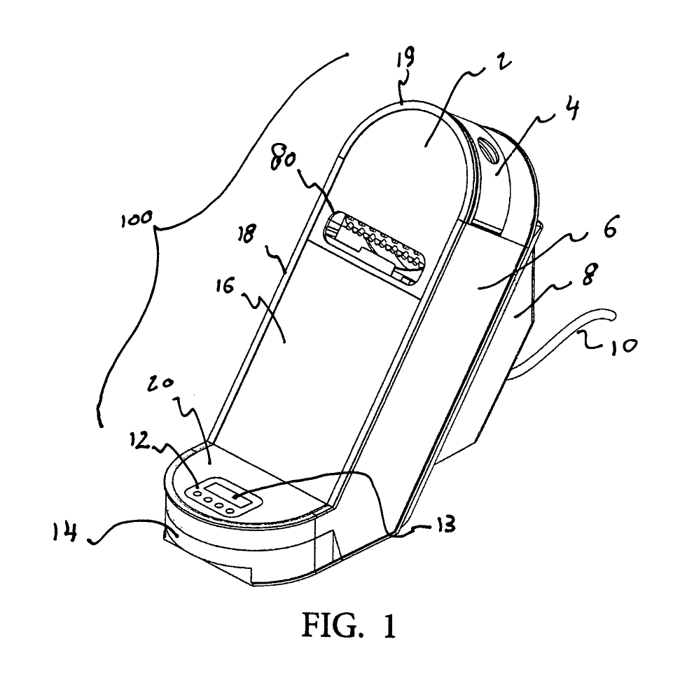

Referring to FIG. 1 we see a perspective view of the invention 100. A main housing 6 encloses the tortilla warming assembly inside. A top lid comprised of an upper lid 2 a middle lid 16 and a lower lid 20 cover the top of the housing. The top pieces 2, 16 are slidably retained in tracks 18 so that they can be removed for cleaning or inspection of inner components. A hinged door 4 can swing open to allow a person to insert a stack of tortillas. A control panel 12 allows a person to program a microprocessor located under the pane 12 to select the number of tortillas to be warmed, and the time duration of warming. In one specific selection, the heating elements in the warming assembly turn on for a few seconds and then turn off for a few seconds, and continue to cycle in this manner for approximately two minutes to allow for even cooking of the tortilla without burning. The electronic display 13 helps prompt the user during setup and also tells the user the progress of the heating process as the unit is working. Upper trim piece 19 if fixed to top cover panel 2 and remains with top cover panel 2 when the panel 2 is removed for cleaning or inspection. Support member 8 holds the main housing 6 in an angled position so that gravity can be used to help tortillas slide from one station to another during the warming process. Top panel 20 remains fixed in position at all times. Lower receiving tray 14 can be slid out by the user after the desired number of warmed tortillas have been delivered into the tray 14.

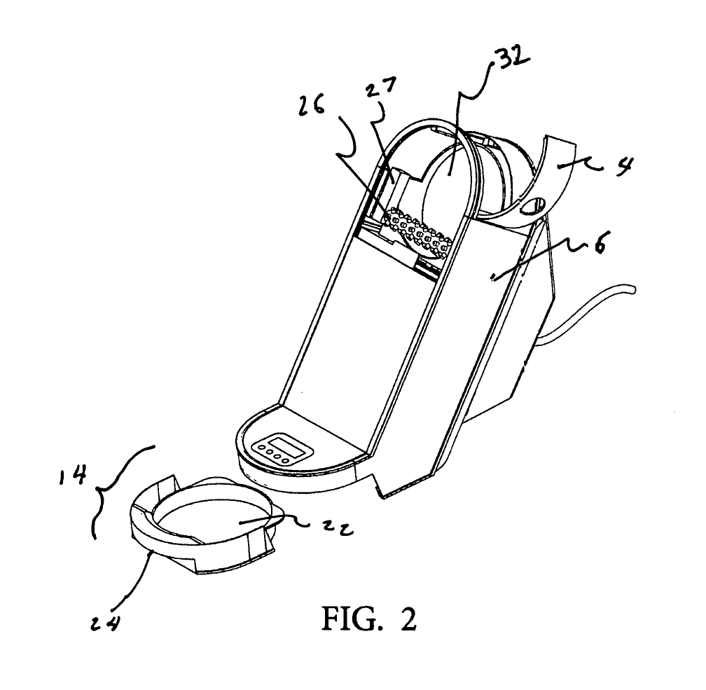

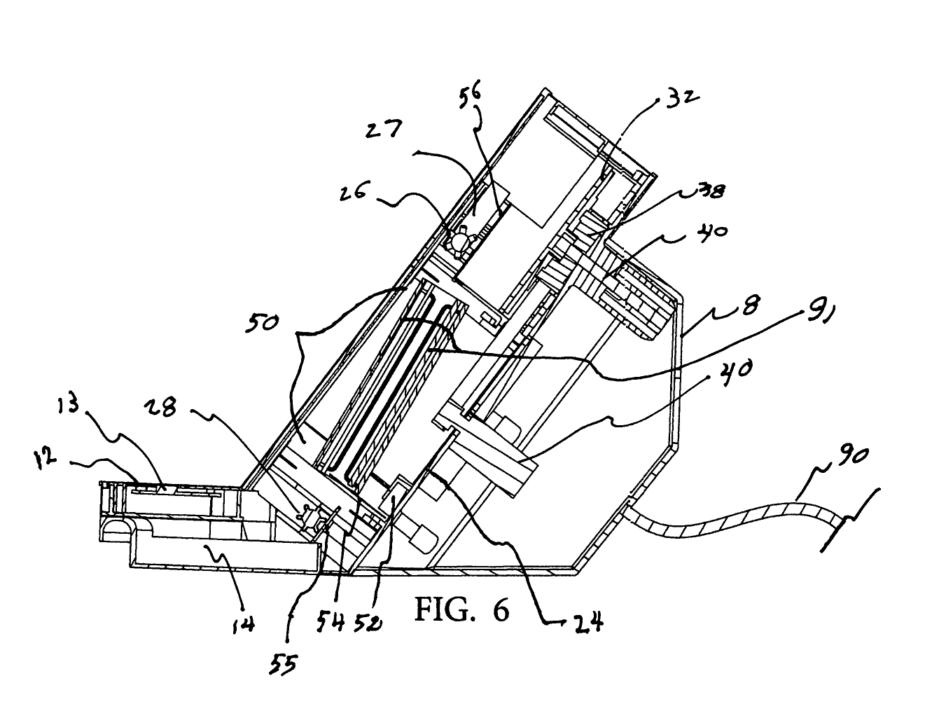

FIG. 2 is a perspective view of the invention 100 showing the bottom receiving tray 14 removed by pulling on handle portion 24. The inside of the tray 22 is designed to hold approximately six tortillas, because the tortillas can become cooled off if not removed and used in a timely fashion. The lift tray 32 and surrounding housing 6 is designed to hold approximately thirty tortillas depending on thickness of each tortilla. Advancing brush 16 can be seen as well as brush motor 27. This rotating brush head 26 engages the top surface of the tortilla being slid into the warming compartment 50, as shown in section view FIG. 6, and helps insure that the tortilla slides fully into the warming compartment.

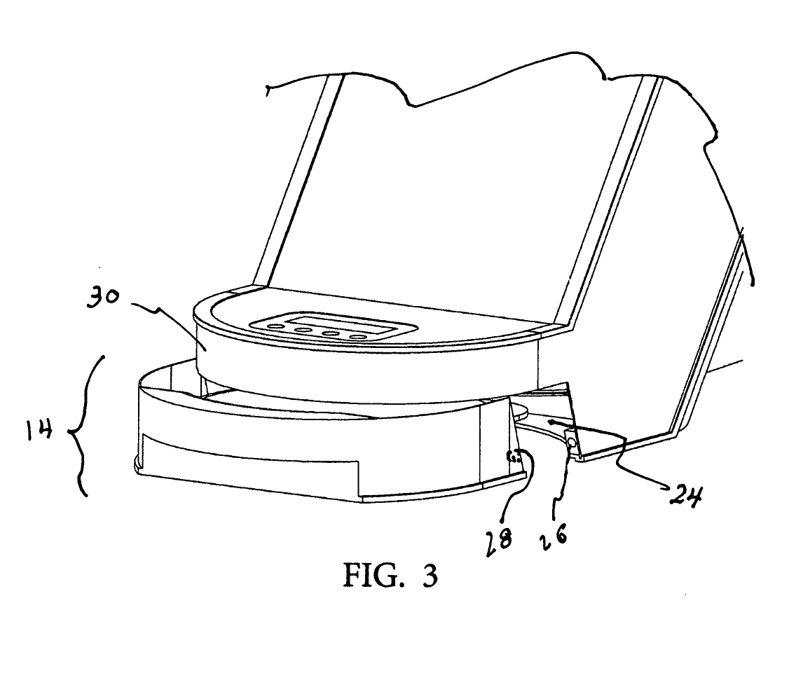

FIG. 3 is a partial perspective view showing receiving tray 14 being removed from under the front housing 30. The tray 14 is removably held in place with the main frame by magnets 26 and 28 shown in dotted lines within tray 14. Similar magnets are also found on the opposite side of the frame 24 and tray 14.

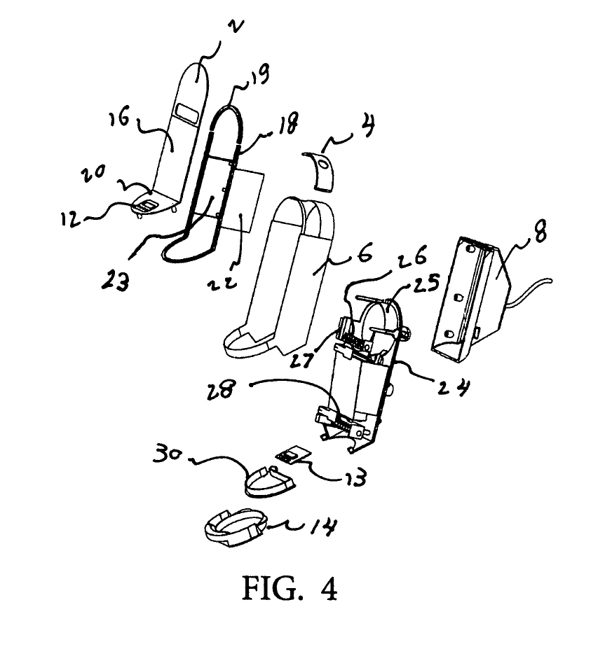

FIG. 4 is an exploded view of the main housing and frame parts of the invention 100. Frame support member 8 attaches to the underside of the main frame member 24 and supports the main frame 24 at an approximately forty-degree angle. Support member 8 also acts as a channel for electrical wires that extend from the microprocessor 13 to the rear portion of the frame 24. Housing 6 attaches to the perimeter of frame plate 24. Channels 18, 19 capture top cover pieces 2, 16, 20. Side support pieces 22, 23 hold the heating assembly 50 in place by means of standard screws. Advancement brushes 26, 28 can be clearly seen.

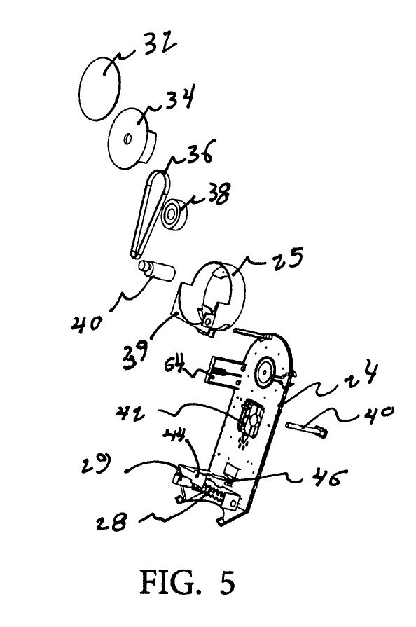

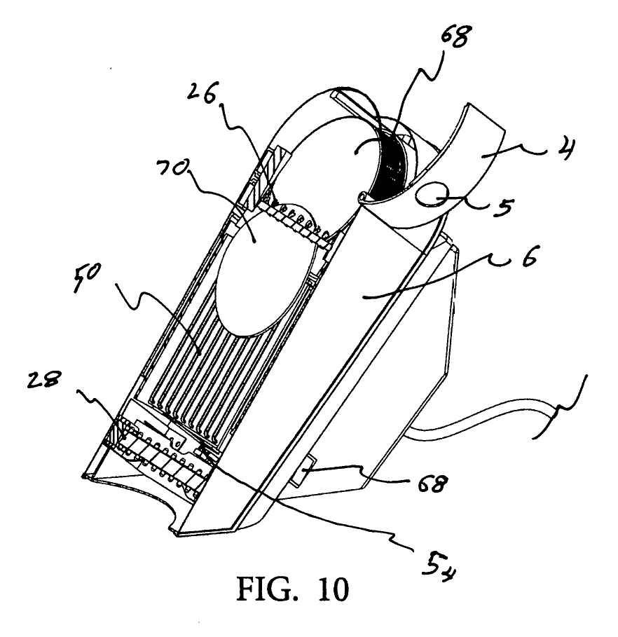

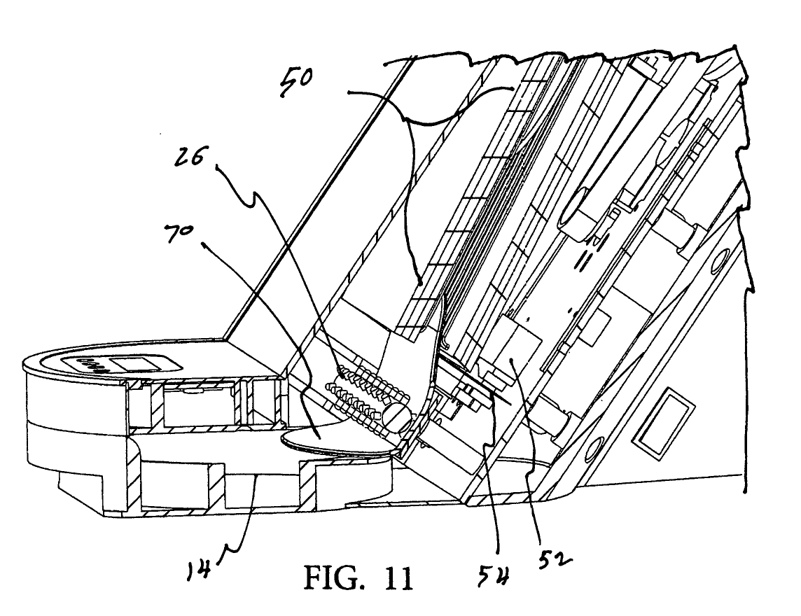

FIG. 5 is an exploded view of the working parts found within the housing 6. Lift plate 32 is attached to the top of lead screw 40 and is forced up or down when the lead screw 40 engages rotating nut 38 which is being rotated by gear motor 40 and timing belt 36. Intermediate panel 34 captures the nut 38 and allows it to rotate. Surround member 25 includes a flat portion 39 which is the top most surface that the uppermost tortilla slides on when transitioning from the stack of tortillas, as shown in the perspective view in FIG. 10, and the warming assembly 50. Side panel 64 allows for correct positioning and fastening for upper brush motor 27. Photo diode 46 shines a UV light up to panel 44. When the light beam is broken by advancing tortilla 70 as shown in FIG. 11, the microprocessor turns the heating element off until the next tortilla is received in the heating compartment 50. Fan 42 blows cooling air up between the front edge of flat portion 39 and the input end of heating compartment 50. The forced air continues out of aperture 80 located in top panel 2 as shown in FIG. 1 to prevent the internal components within the housing 6 from overheating during use.

FIG. 6 is a section view which bisects the invention 100. Lifting plate 32 is at its lowest level and is ready to receive a stack of tortillas as shown in FIG. 10. When a tortilla reaches the top 56 of the tortilla retaining compartment, it begins to slide toward the heating compartment 50 by gravitational force and is assisted by advancing brush 26 as described above. The tortilla is then retained in the central portion of heating assembly 50 and kept from sliding out by gate 54 which is powered by gear motor 52. A plurality of switches 12, also shown in FIG. 1 allow a user to program the microprocessor 13 to select number of tortillas to be warmed and warming time for each tortilla. When gate 54 opens, the tortilla drops onto platform 55 where lower advance brush 28 insures that the tortilla transitions completely into waiting tray 14. Frame support member 8 can be clearly seen in its role as positioning the frame plate 24 in an approximately forty-degree angle with respect to the horizontal plane. Power cord 90 supplies AC voltage to the electronic components including nichrome wire heating elements 91. Lift plate drive motor 40 can be seen as well as lead screw 40 and nut 38.

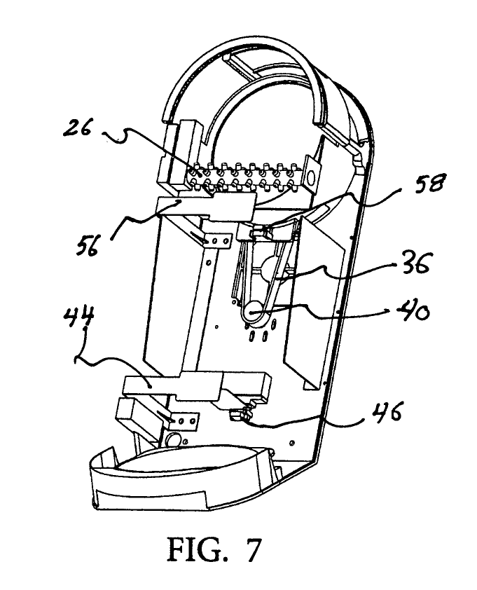

FIG. 7 is a perspective view showing motor pully 4 driving timing belt 36 which is attached to the nut 38. Photo diode 46 can be clearly seen as well as beam stopping panel 44. The beam is projected up to panel 44 and when broken by a tortilla, the lower advancing brush is activated and the heating elements 91 are turned off. Photo diode 58 acts in the same way in conjunction with beam stopping panel 56 to turn on the heating element 91 when a tortilla breaks the plane on its way to the heating compartment 50.

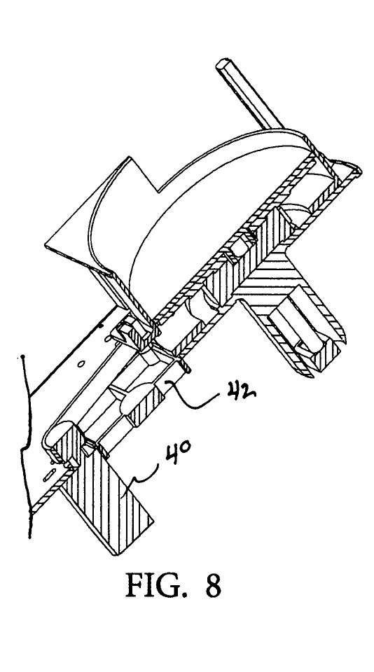

FIG. 8 clearly shows drive motor 40 as well as blower fan 42.

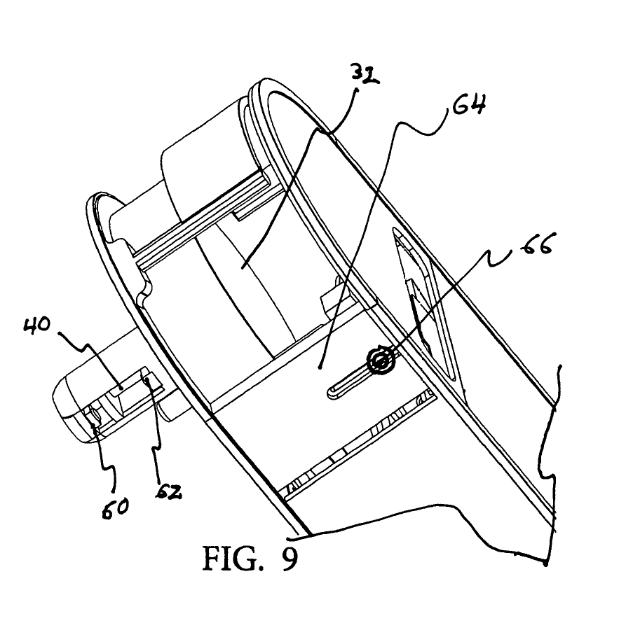

FIG. 9 clearly shows limit switches 60, 62 which are activated when lead screw 40 reaches its lower-most or upper-most points. When the user turns on the main on-off switch 68 as shown in FIG. 10, the lift plate 32 returns to its lowest position so that it may be loaded with new tortillas. When the lead screw 40 reaches its top-most position. The microprocessor knows that the last tortilla has been warmed and that it is time to load in new tortillas. The visual display 13 indicates these conditions to the user along with number of tortillas left to be warmed and a warming countdown for the tortilla currently being warmed. Bold 66 fixes the upper brush advance motor 27 to side wall 64.

FIG. 10 shows a tortilla 70 being moved into the heating chamber 50 via the natural force of gravity, and advance brush 26. The tortilla 70 will be retained inside the heating chamber 50 by exit gate 54.

FIG. 11 shows exit gate 54 in the lowered position via gear motor 52 allowing the tortilla 70 to be slid into the retaining tray 14 by the action of advancing brush 26 as well as the natural force of gravity. The brush 26 insures that the tortilla 70 fully completes its journey into waiting tray 14.

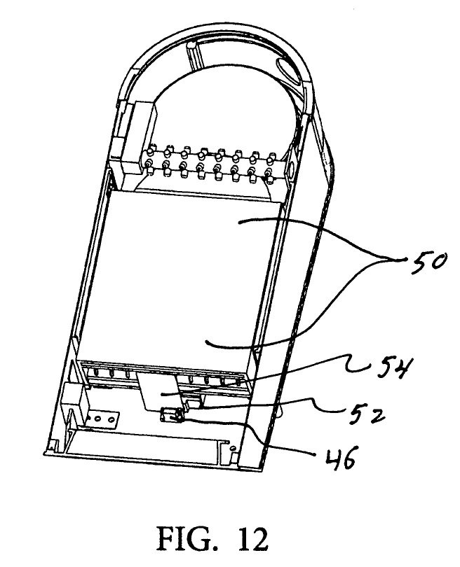

FIG. 12 clearly shows exit gate 54 in the up position as it prevents a tortilla from exiting the bottom channel of heating chamber 50.

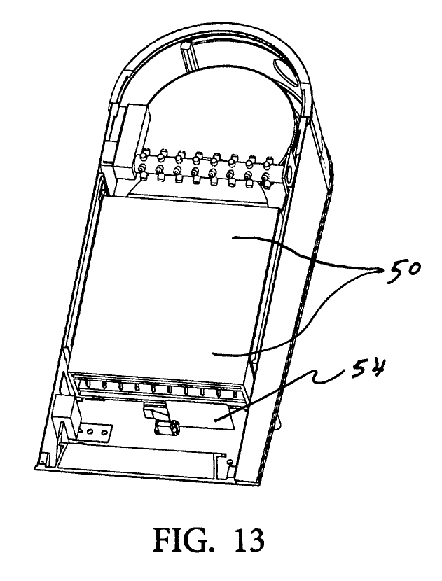

FIG. 13 clearly shows the exit gate 54 in the lowered position thereby allowing a tortilla to exit the bottom channel of heating chamber 50.

The above descriptions and accompanying illustrations show that the present invention can automatically allow a plurality of tortillas to be warmed, one at a time, and to be delivered to a receiving tray where they can then be taken to a dining location such as a dining table. The entire process is done automatically and free from human intervention thereby allowing all those involved in the partaking of the tortillas to be free to do so without the continual disruption of checking on the progress of warming tortillas. The device is light weight and portable and can be placed directly on a table where tortillas are being prepared and consumed. It also should be noted that one version of the present invention can include the ability to start and program the tortilla heater remotely via a hand held remote or via a smart phone ap.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. tortilla warmer comprising:
a main frame;
a lift plate assembly;
a first advance brush assembly;
a second advance brush assembly;
an electric warming assembly;
an exit gate assembly;
a lower tortilla receiving tray;
a microprocessor;
a display;
an on off switch;
a plurality of microprocessor selection switches;
a main housing;
a top cover;
said main frame supporting all said assemblies;
said main housing being open topped and enclosing all said assemblies;
said lift plate assembly capable of receiving a stack of tortillas and lifting them one at a time to be dropped into said electric warming assembly;
said lifted tortilla forced into said electric warming assembly with the aid of said first advance brush assembly;
said lifted tortilla prevented from leaving said electric warming assembly during the warming process by said exit gate assembly;
said warmed tortilla allowed to leave said electric warming assembly once fully warmed by the lowering of said exit gate assembly and to fall into said lower tortilla receiving tray with the assistance of said second advance brush assembly;
said tortilla warming controlled by said microprocessor, said selection switches and said display;
said upper top cover forming the top of said main housing;
said on-off switch controlling the supply of AC voltage powering said tortilla warmer; and
so that a stack of tortillas can be inserted onto said lift plate assembly and said lift plate assembly can lift said stack of tortillas so that each tortilla exits the said stack one at time and are warmed one at a time and then allowed to proceed into said lower tortilla receiving tray and where said lower receiving tray can be removed and brought to a desired eating location.

2. A tortilla warmer as claimed in claim 1 further comprising a first photodiode member and a second photodiode member;
said first photodiode member positioned to sense the arrival of said lifted tortilla causing said microprocessor to instruct said electric heating element to turn on;
said second photo diode member positioned to sense the exit of said tortilla from said electric warming assembly and to turn off said heating element.

3. A tortilla warmer as claimed in claim 1 wherein said first and second brush assemblies said gate assembly and said lift plate assembly are each powered by a gear motor controlled by said microprocessor.

4. A tortilla warmer as claimed in claim 1 wherein said lift plate assembly includes a lift screw, a nut and a lift plate wherein said gear motor rotates said nut causing said screw and attached lift plate to rise or fall as needed.

5. A tortilla warmer as claimed in claim 4 further comprising a lower stop switch and an upper stop switch which can tell said microprocessor when said lift plate is at its lowest point or at its highest point.

6. A tortilla warmer as claimed in claim 1 wherein said electric warming assembly consists of an upper nichrome wire panel and a lower nichrome wire panel and a tortilla support grid all located in a heat resistant housing forming a through channel to allow said tortillas into the top of the said channel and out through the bottom of said channel.

7. A tortilla warmer as claimed in claim 1 wherein said lift tray and said electric warming assembly are approximately parallel with each other and are both tilted at an approximately forty-degree angle with respect to a horizontal plane.

8. A tortilla warmer as claimed in claim 1 further comprising a hinged door located in the side wall of said housing to allow a person to insert a stack of tortillas and place them onto said lift plate.

9. A tortilla warmer as claimed in claim 1 further comprising an electric fan located on the underside of said housing and blowing air up through the space between said lift plate and said electric heating assembly.

10. A tortilla warmer as claimed in claim 5 wherein an aperture in said top plate allows forced warm air to escape from said main housing.

11. A tortilla warmer as claimed in claim 1 wherein said tortilla warmer is operated remotely placing a receiving circuit within said main housing and by operating a hand-held transmitter or a smart phone ap developed specifically for the purpose of operating said tortilla warmer.
